(19) United States
(12) Patent Application Publication
(10) Pub. No.: US 2019/0090558 A1
(43) Pub. Date: Mar. 28, 2019

(54) Molded Respirator with Integral Nose Pads Provided by Inwardly-Folded Tabs

(71) Applicant: 3M INNOVATIVE PROPERTIES COMPANY, St Paul, MN (US)

(72) Inventors: Feng Xu, Shanghai (CN); Dean R. Duffy, Woodbury, MN (US); Hua Jin, Hwaseong-si (KR); Jungchul Moon, Hwaseong-si (KR); Dong-Sun Noh, Gunpo-si (KR); Daniel J. Stepan, Woodbury, MN (US)

(21) Appl. No.: 16/300,365

(22) PCT Filed: May 12, 2016
(86) PCT No.: PCT/CN2016/081808

§ 371 Date: Nov. 9, 2018

(51) Int. Cl. A41D 13/11; A62B 23/02

(52) U.S. Cl. CPC A41D 13/1146; A41D 13/1161; A62B 23/025

(57) ABSTRACT

A filtering face-piece respirator (10) having a cup-shaped, molded mask body (20) and having integral nose pads (21, 26) provided by inwardly-folded tabs (41, 46), which tabs (41, 46) are integral extensions of at least one layer of the mask body (20).

### BACKGROUND

Respirators are often worn in the workplace e.g. to minimize the chance of undesired particles entering a wearer's respiratory system.

### SUMMARY

In broad summary, herein is disclosed a filtering face-piece respirator comprising a cup-shaped, molded mask body and comprising integral nose pads provided by inwardly-folded tabs, which tabs comprise integral extensions of at least one layer of the mask body. These and other aspects of the invention will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a front/side perspective view of an exemplary filtering face-piece respirator in generic representation.

FIG. 2 is rear plan view of the respirator of FIG. 1.

FIG. 3 is a rear plan view of an exemplary layer of a cup-shaped, molded mask body, with tabs in an outwardly-extended position.

FIG. 4 is a rear plan view of the layer of FIG. 3, with the tabs in an inwardly-folded position.

FIG. 5 is a rear perspective view of another exemplary layer of a cup-shaped, molded mask body, with tabs in an outwardly-extended position.

FIG. 6 is a rear plan view of the layer of FIG. 5, with the tabs in an inwardly-folded position.

FIG. 7 is a rear perspective view of another exemplary layer of a cup-shaped, molded mask body, with tabs in an inwardly-folded position.

FIG. 8 is a rear perspective view of another exemplary layer of a cup-shaped, molded mask body, with tabs in an outwardly-extended position.

FIG. 9 is a rear plan view of another exemplary filtering face-piece respirator.

FIG. 10 is a front/side perspective view of the respirator of FIG. 9.

FIG. 11 is a front/side perspective exploded view of the respirator of FIG. 10.

Like reference numbers in the various figures indicate like elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated. Although terms such as “first” and “second” may be used in this disclosure, it should be understood that those terms are used in their relative sense only unless otherwise noted. As used herein, terms such as “forward” and “front” denote a direction generally away from a wearer's face and terms such as “rearward” and “rear” denote a direction generally toward a wearer's face (all descriptions of the herein-disclosed respirator are with reference to the respirator being properly fitted in position on a user's face, unless otherwise noted). Terms such as “inward” and “inner” denote a direction away from the perimeter of the respirator, generally toward a central location (e.g., a geometric center) within the interior air space defined by the respirator. Terms such as “outward” and “outer” denote a direction that is away from such a geometric center, e.g. toward and/or past the perimeter of the respirator. Terms such as upper, lower, and vertical, have their customary meaning. By lateral is meant a side-to-side direction that is generally perpendicular to the vertical axis of the mask body (and thus to the sagittal plane of the wearer).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

### DETAILED DESCRIPTION

### Glossary

“Filtering face-piece respirator” denotes a respirator with a mask body that is designed to filter air that passes through it; by definition there are no separately identifiable filter cartridges that are e.g. attached or connected to the mask body to achieve this purpose.

By a “cup-shaped” mask body of a filtering face-piece respirator is meant that the mask body is shaped into a generally cup-shaped form (with a bulbous portion that defines a volume within which a portion of the wearer's nose and mouth reside) and retains that form when not in use, unless the mask body is actively laterally compressed as disclosed herein.

By a “molded” mask body of a filtering face-piece respirator is meant that at least one layer (e.g., a shaping layer) of the mask body is molded (e.g., thermoformed) by heat and pressure into a cup-shaped form that causes the mask body to be cup-shaped as defined above.

By a “nose pad” is meant a component of a filtering face-piece respirator that, when the respirator is worn by a wearer, presses toward and/or abuts the nose of the wearer so as to enhance the fit of the respirator in the nose area. A nose pad may, but does not have to, contact the wearer's nose directly; for example in some embodiments it may urge some other component (e.g. a portion of a face seal) toward the wearer's nose.

“Integral” refers to items that are made of the same material and were made at the same time as a single part, and are not two separate parts subsequently joined together.

“Face seal” means a sheet-like structure that extends inwardly from a perimeter of the open end of a mask body of a respirator, that is sufficiently conformable to adjust to the contours of a wearer's face when the respirator is worn by a wearer, and that helps minimize or prevent the entry of particles into an interior air space.

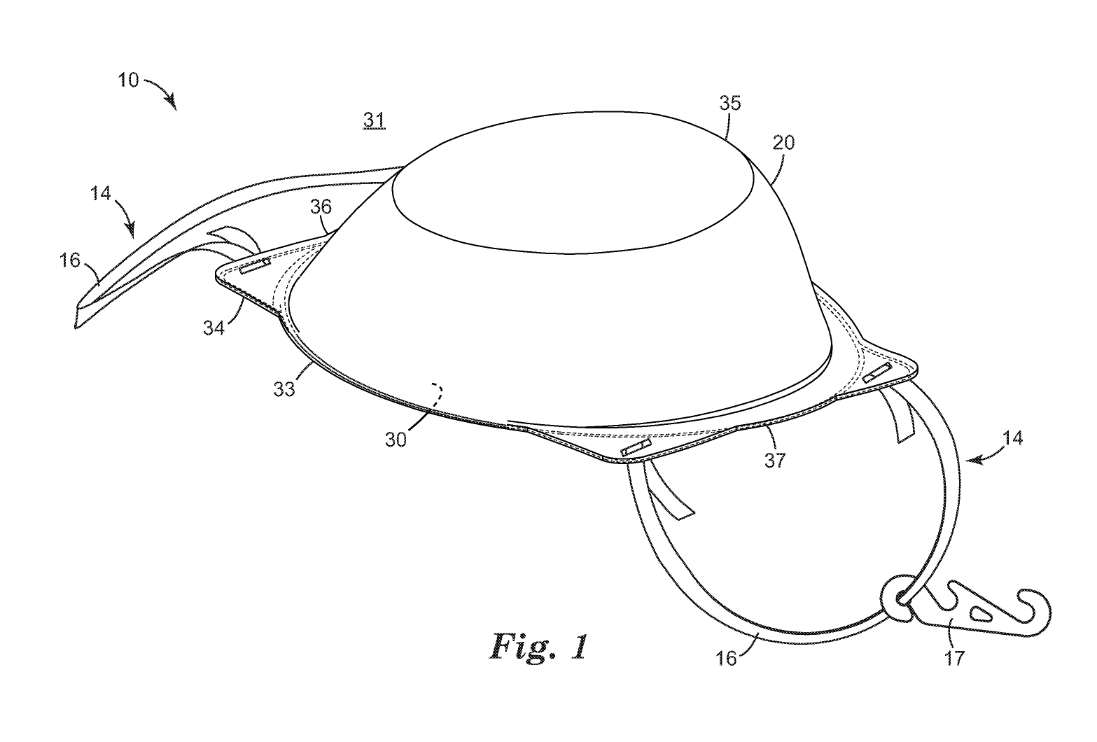

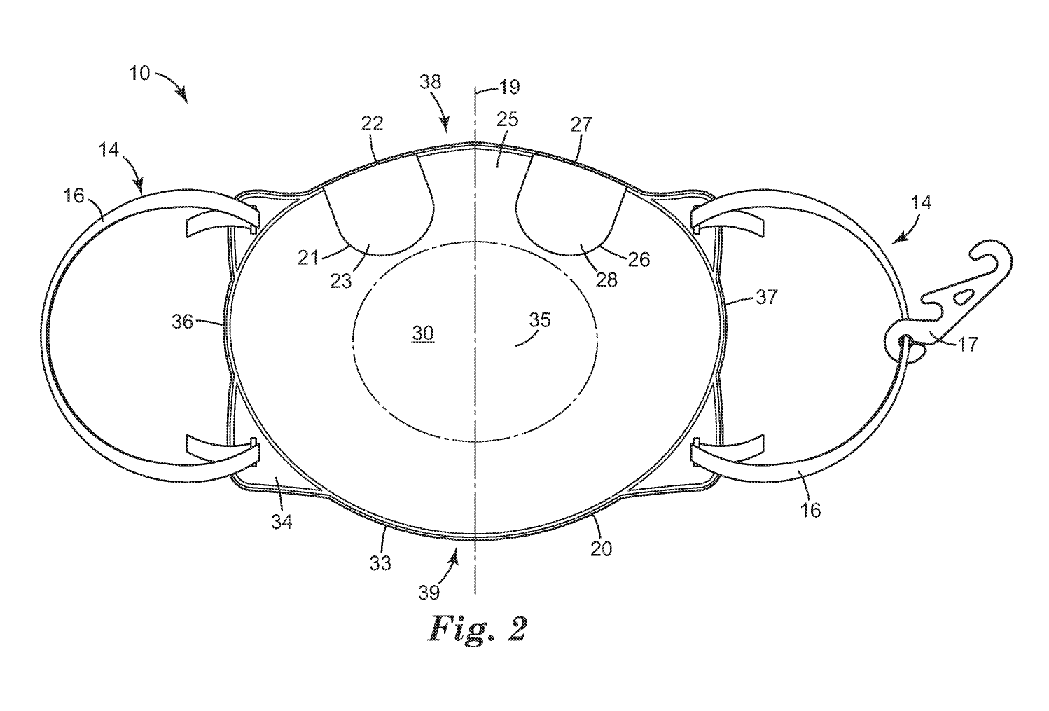

A shaped filtering face-piece respirator 10 is shown in exemplary embodiment, in front-side perspective view in FIG. 1 and in rear plan view in FIG. 2. Respirator 10 comprises cup-shaped, molded mask body 20, that is bounded by perimeter 33 and that has upper and lower ends 38 and 39 and first and second lateral edges 36 and 37. Mask body 20 is shaped to form an interior air space 30 around the nose and mouth of the wearer so as to separate this space from exterior air space 31 e.g. so that any air that enters interior air space 30 from exterior air space 31 must pass through a filter layer of mask body 20. Cup-shaped mask body 20 comprises a bulbous portion 35 that protrudes forwardly (i.e., in a direction away from the wearer's face) from perimeter 33 of mask body 20. The characterization of mask body 20 as cup-shaped broadly encompasses any desired bulbous shape (resembling e.g. a cup or bowl). There is no requirement of any specific geometric configuration (e.g. the bulbous shape is not required to be perfectly hemispherical, or to have a flat forward surface, and so on). For example, bulbous portion 35 of mask body 20 may exhibit a shape that resembles a paraboloid, a bicorn, and so on.

FIG. 2 depicts exemplary respirator 10 from the rearward, open end of respirator 10. In this view are visible first and second integral nose pads 21 and 26. First nose pad 21 is provided by a first inwardly-folded tab that is an integral extension of at least one layer of the mask body (as discussed in detail later herein) and that extends inwardly from a first upper section 22 of perimeter 33 of mask body 20. Second integral nose pad 26 is similarly provided by a second inwardly-folded tab that is an integral extension of the at least one layer of the mask body (in other words, the second tab is an integral extension of the same layer or layers of the mask body that the first tab is an integral extension of). In at least some embodiments, the first and second tabs are both integral extensions of a molded layer (e.g., a shaping layer) of mask body 20, as discussed in detail later herein. Second nose pad 26 extends inwardly from a second upper section 27 of perimeter 33 of mask body 20. Nose pads 21 and 26 as shown in exemplary embodiment in FIG. 2 exhibit relatively straight, parallel sides and uniformly rounded inward terminal ends. However, a nose pad can be any desired shape, e.g. rectangular or square (e.g. with a terminal end that is straight rather than rounded), triangular or trapezoidal (e.g. narrowing to a terminal end), and so on, and in particular can have an inward terminal end and/or side edges that are e.g. straight, curved, serrated, irregular, and so on.

First nose pad 21 comprises a rearward major surface (that is, a surface that faces generally toward the wearer's face, e.g. toward the nose) 23; second nose pad 26 similarly comprises a rearward major surface 28. In some embodiments, such a major surface may be provided by the integrally-extending layer of the mask body itself (or by a surface of the rearmost of a stack of layers). In other embodiments, a functional layer may be provided on the rear side (or optionally, on the front side) of a nose pad as discussed later herein. In some embodiments, a nose pad may reside forward of a component such as e.g. a face seal, again as discussed later herein. In other words, a nose pad, and in particular the layer(s) of a nose pad that integrally extends from the mask body, may be, but does not necessarily have to be, in direct contact with a wearer's nose.

In various embodiments nose pads 21 and 26 may have a minimum extent (i.e., length) in the inward-outward direction of the mask body, of at least about 10, 14, 18, or 22 mm. In further embodiments nose pads may have a maximum extent of at most about 36, 32, 28, or 24 mm. First and second integral nose pads 21 and 26 are positioned on first and second sides (left and right sides in the view of FIG. 2) of a vertical bisector 19 of the mask body. The first and second pads are discrete so as to have a gap (notch) 25 therebetween. Gap 25 can have any desired shape and aspect ratio and in some embodiments may have an inward-outward extent (length) that is slightly less (e.g., no more than 10, 20, or 30% less) than the inward-outward extent of each nose pad. Vertical bisector 19 of the mask body will intersect the gap 25 between the first and second integral nose pads. In many embodiments, the tabs will be symmetrical so that vertical bisector 19 bisects gap 25 (as in the exemplary arrangement shown in FIG. 2). In at least some embodiments nose pads 21 and 26 only extend (along perimeter 33 in a direction opposite gap 25) to the end of first and second upper sections 22 and 27 e.g. as shown in FIG. 2. That is, the nose pads will not extend all the way to first and second lateral edges 36 and 37 of the mask body. In various embodiments nose pads 21 and 26 may each have a minimum length along perimeter 33 of the mask body (measured at a location 5 mm inwardly from the junction of the nose pad with the mask body) of at least about 10, 20, 30, 40 or 50 mm. In further embodiments the nose pads may have a maximum length of at most about 60, 50, 40, 30, or 25 mm.

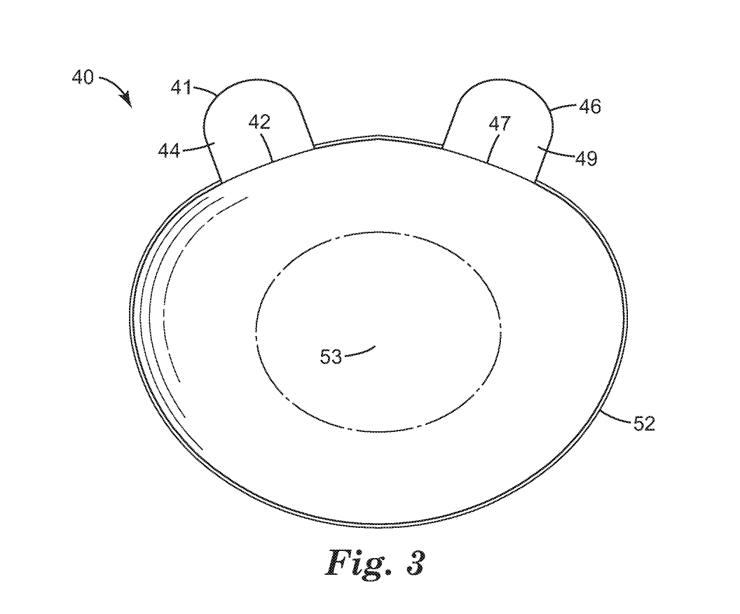

With reference to FIG. 3, first and second nose pads 21 and 26 will be respectively provided by first and second tabs 41 and 46 of at least one layer 40. (FIG. 3 is an isolated view of a layer 40 of cup-shaped molded mask body 20, showing tabs 41 and 46 prior to their having been folded inwardly to form nose pads 21 and 26.) First and second tabs 41 and 46 are integral extensions of at least one layer of mask body 20. In various embodiments, such a layer of mask body 20 may be e.g. an outer cover layer, a filter layer, or an inner cover layer. In particular embodiments, such a layer may be a molded layer, e.g. a so-called shaping layer. In some embodiments, first and second tabs 41 and 46 may be integral extensions of multiple layers of mask body 20, as discussed in detail later herein. Tabs 41 and 46 are made of the same material as layer 40 of mask body 20 (including any sublayers thereof) and integrally extend therefrom. It will be appreciated that an arrangement as shown in FIG. 3 can be obtained by e.g. subjecting layer 40 (e.g. as a sheet) to a molding (e.g. thermoforming) process so as to form a bulbous portion 53 (which will provide a layer of bulbous portion 35 of the mask body), and trimming excess material to leave layer 40 with a cup-shape defined by perimeter 52 and to also leave layer 40 with outwardly-extending tabs 41 and 46.

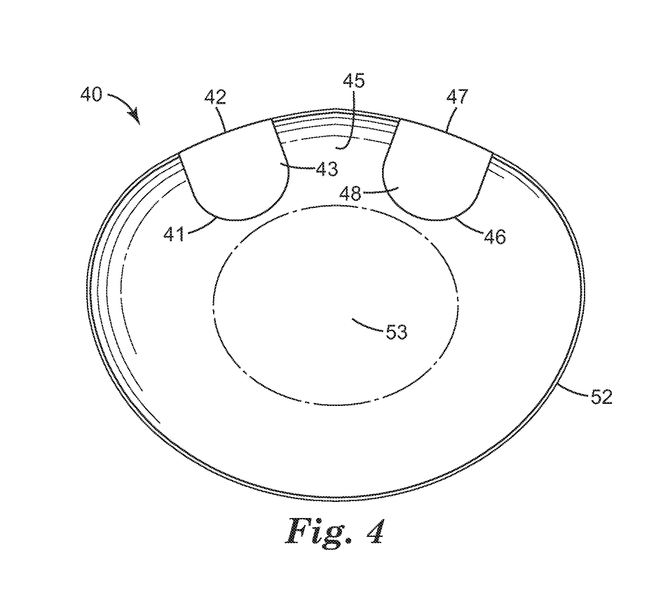

As is evident from FIG. 4, tabs 41 and 46 are inwardly folded in production of respirator 10, meaning that they are folded so as to extend at least generally toward the geometric center of layer 40 of mask body 20 (noting that in their initial configuration as shown in FIG. 3, tabs 41 and 46 extend outwardly, away from such a geometric center). Such folding may be along a folding line that may be, but does not have to be, coincident with sections 42 and 47 of perimeter 52. In some embodiments perimeter 52 may be e.g. ultrasonically welded to other layers of mask body 20, which may reinforce or stiffen the resistance of perimeter 52 to twisting. In such cases, the actual folding line may thus be e.g. slightly outward (in the view of FIG. 3) along the tab rather than exactly at the mask body perimeter. And, in some embodiments the “folding” of a tab may occur along a relatively significant portion of its inward-outward length rather than occurring purely along a very narrow “line” in the manner shown in FIG. 4.

Such a folding process will first move the terminal end of a tab rearward (and inward) from its initial position of FIG. 3. After the tab has traversed an arc of approximately 90 degrees, the terminal end will now be moving forward and inward. The folding can be continued to any desired degree. In some embodiments, the folding may be performed such that the tabs each move through a folding angle of from e.g. 120 to 180 degrees (with the reference condition being the tabs in their initial, unfolded configuration as shown in FIG. 3). In such cases, the tabs (and resulting nose pads) when in their inwardly folded configuration, may still protrude slightly rearward from perimeter sections 22 and 27 of mask body 20, e.g. until they are deflected forward by the wearer's nose when the respirator is worn. In some embodiments the folding may be such that the tabs each move through a folding angle of e.g. 180 to 230 degrees. In such cases, the resulting nose pads may extend slightly forward from perimeter sections 42 and 47 of mask body 20, even before the respirator is fitted to the face of a user. Thus in various embodiments, the tabs may each be folded through a folding angle of at least about 120, 130, 140, 150, 160, 170, 180, or 190 degrees. In further embodiments, the tabs may each be folded through a folding angle of at most about 230, 220, 210, 200, 190, 180, 170, 160, or 150 degrees.

It will be appreciated that in at least some embodiments, folding the first and second tabs inwardly, away from their initial configuration (of FIG. 3), can cause the tabs to be biased toward unfolding back toward their initial configuration (due e.g. to the resilience of the components of the layers of the mask body and tabs). This biasing may provide that, when respirator 10 is worn, nose pads 21 and 26 press toward the nose and thus enhance the fit of mask body 20 in and around the nose of the wearer. This effect may be enhanced by the presence on the tabs of e.g. one or more 3-D features and/or one or more functional layers as disclosed later herein. In some embodiments, rearward surfaces 43 and 48 of first and second tabs 41 and 46 may be the rearmost (e.g., nose-contacting) surfaces of nose pads 21 and 26; in other embodiments, surfaces of other layers (e.g., functional layers) may serve such a function.

In at least some embodiments, tabs 41 and 46 (and thus nose pads 21 and 26) are not attached to mask body 20 at any location other than at perimeter 33 of the mask body (e.g. along sections 22 and 27 of perimeter 33 as shown in FIG. 2). That is, in such embodiments a tab is not, for example, inwardly folded and then tacked or otherwise attached to an area of bulbous portion 35 of the mask body. The absence of any such additional attachment may, for example, provide that the resulting nose pad is free to move (e.g. rotate) about the perimeter attachment location and thus can be advantageously biased toward unfolding as discussed above.

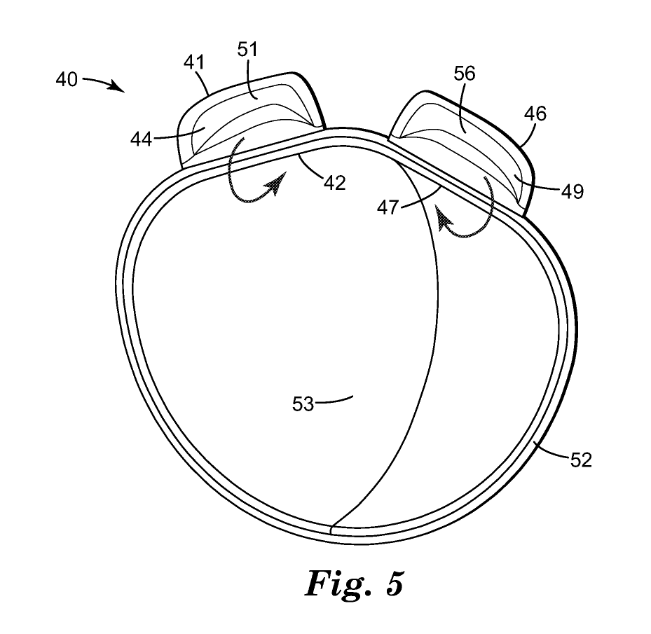

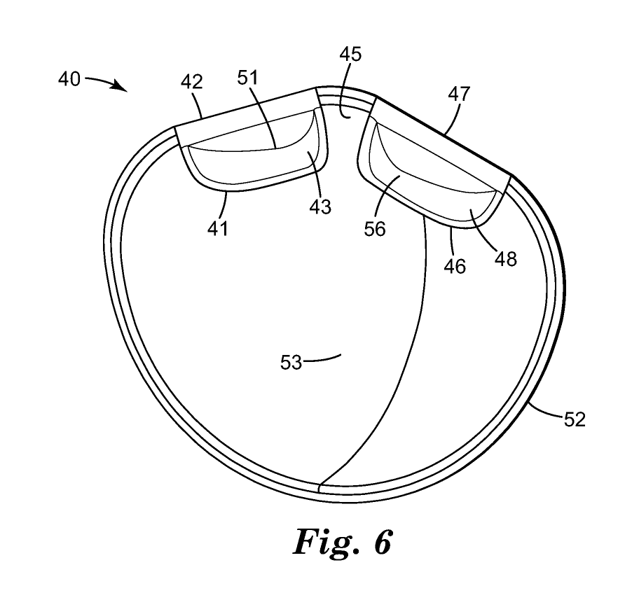

With reference to FIG. 5, in some embodiments at least a portion of tab 41 and a portion of tab 46 may be shaped so as to exhibit a three-dimensional shape that can enhance the performance of nose pads 21 and 26. For example, the tabs may be molded (e.g., thermoformed) by heat and pressure. (This may be conveniently done in the same molding process in which bulbous portion 53 of layer 40 is formed.) 3-D features 51 and 56 thus may be imparted to tabs 41 and 46, such that when the tabs are inwardly folded as described above, features 51 and 56 provide rearwardly-convex portions of the tabs (that is, they are portions that protrude rearwardly from the other portions of the tabs) as shown in FIG. 6. It will be appreciated that such features can enhance the fit of mask body 20 in and around the nose of the wearer.

Rather than a tab being shaped (e.g. molded) to have a single 3-D feature as in FIGS. 5 and 6, in some embodiments a tab can be shaped to have a plurality of 3-D features, e.g. in a pattern. Such features can take the form of e.g. protrusions, dimples, grooves, ridges, and so on, and can be achieved e.g. by molding (e.g. thermoforming), by ultrasonic welding, by embossing, and so on. Such features may serve e.g. to increase or reduce the stiffness and rigidity of the tabs.

In some embodiments, tab 41 and/or tab 46 may comprise at least one functional layer that is disposed thereon. (A nose pad 21 or 26 may thus be comprised of tab 41 or 46 along with any functional layer(s) provided thereon.) For example, such a functional layer may be disposed on a rearward surface 43 or 48 of tab 41 or 46, or on a forward surface of such a tab. In this context, the term functional layer is used to designate a layer that is provided only on a tab (and on the resulting nose pad) and possibly may be provided on a relatively small portion of mask body 20 as described below. A functional layer is thus distinguished from a layer that is present over essentially the entirety of mask body 20 and that the tab is be an integral extension of. (In other words, a functional layer is distinguished from e.g. inner and outer cover layers, filter layers, and shaping layers, of a mask body.)

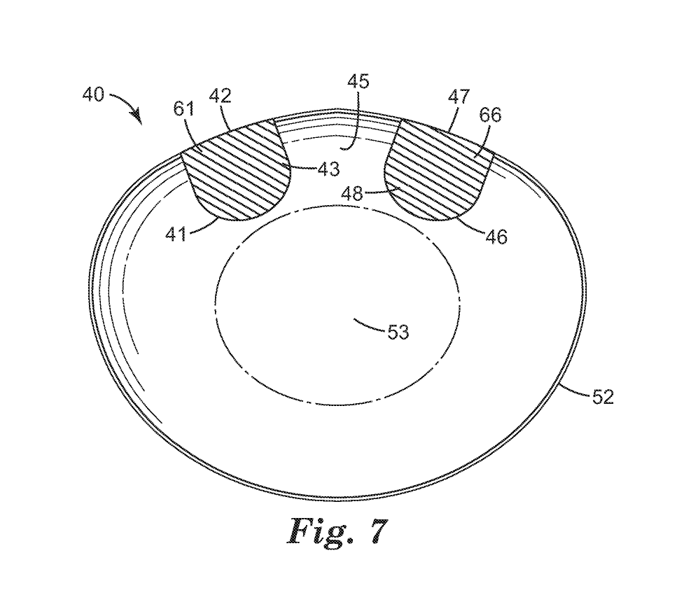

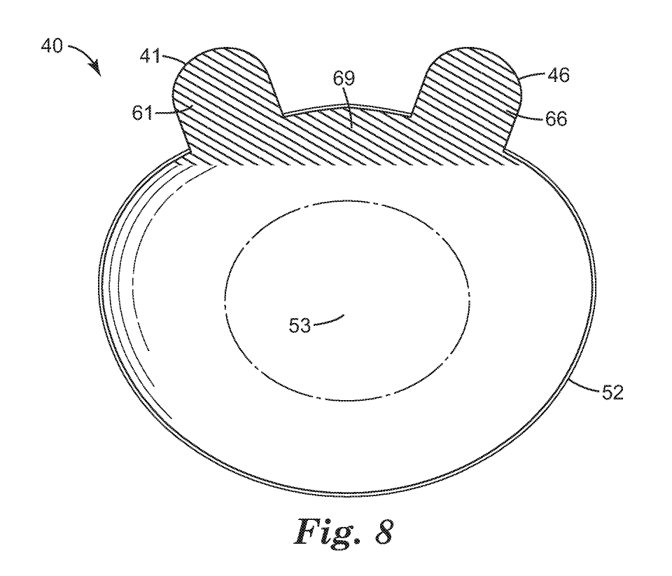

In some embodiments a functional layer may be present only on tabs 41 and 46 and not on any portion of mask body 20, as shown in exemplary embodiment in FIG. 7. (In FIG. 7, functional layers 61 and 66 are respectively on a major rearward surfaces 43 and 48 of tabs 41 and 46.) In some embodiments the functional layer may additionally be present on an upper portion of the mask body, e.g. a portion in proximity to the tabs, as shown in exemplary embodiment in FIG. 8. In some embodiments, functional layer 61 of tab 41, functional layer 66 of tab 46, and functional layer 69 of mask body 20, may all be integral portions of the same functional layer, again as shown in FIG. 8. It will be appreciated that this may be conveniently accomplished e.g. by bonding (e.g. laminating) a strip of functional material to the sheet of material from which layer 40 is to be formed, with a part of the strip positioned on the areas of the sheet that will become the tabs and with a part of the strip positioned on an area of the sheet that will become a portion of the mask body. Such an approach will result in the functional material being on the same side of the mask body as on the tabs; thus, in the rear view of FIG. 8, the functional material is on the side of the tabs that will provide the front surface of the tabs once the tabs are inwardly folded. It is also possible to put a strip of functional material on the opposite side of the sheet of material, so that the functional material will end up on the rear side of the tabs, once the tabs are inwardly folded.

In some embodiments tabs 41 and 46 bearing a functional layer may be molded (e.g. thermoformed) as described above, with the functional material being likewise molded during this process. (It will also be appreciated that tabs that include multiple sublayers may also be molded in this manner.) Thus, 3-D features may be imparted to tabs that include functional layers and/or multiple sublayers.

A functional layer may comprise any desired functional material, to serve any purpose or to impart any desired property. In some embodiments, a functional layer may be a decorative layer that exhibits a particular color, visual appearance, or the like. Such a layer may be comprised of any desired material, including e.g. one or more of dyes, pigments, fillers, and so on. Such a layer may exhibit any desired surface texture or the like, e.g. in aid of a particular visual appearance. In some embodiments, a functional layer may be a cushioning layer that may e.g. provide additional comfort to the nose of a wearer of the respirator. Such a cushioning layer may be chosen from any suitable material, e.g. an open or closed cell foam, a soft nonwoven, and the like. In some embodiments a functional layer may be an occluding layer, meaning a layer that is designed to conform to any gaps that might otherwise be present between the nose pad and the wearer's nose. Such an occluding layer may, for example, serve as an anti-fog layer by physically blocking exhaled air from reaching the eyeglasses of a wearer of the respirator. In some embodiments a functional layer may be a wicking layer that serves to wick liquid water away from the skin of a wearer of the respirator. Such a wicking layer may be chosen from any suitable material, e.g. a nonwoven web with fibers of composition chosen for their ability to wick water; or, a film bearing microchannels of geometry and composition chosen for their ability to wick water. In some embodiments a functional layer may be a non-slip layer, which may enhance the ability of the mask body to resist moving on the wearer's face, particularly in the presence of moisture. Such a non-slip layer might comprise e.g. a soft and rubbery material and/or a material with a high coefficient of friction, or even a pressure-sensitive adhesive material. If desired, a surface (e.g., a rear-facing surface) of a functional layer may exhibit a surface texture; such texture may be particularly helpful if the functional layer is to serve e.g. as a non-slip layer or a wicking layer. It will be appreciated that there is not necessarily a bright-line difference between materials of the above categories, and some materials may serve more than one function. For example, many materials may serve as both a cushioning layer and an occluding layer.

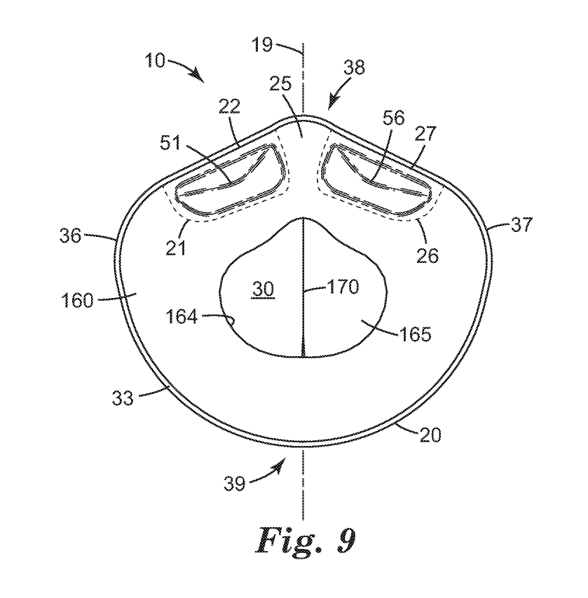

In some embodiments, respirator 10 may include a face seal 160 as shown in exemplary embodiment in FIG. 9. Face seal 160 is provided on the open (rear) side of respirator 10 and can provide a comfortable fit against a wearer's face while also helping to minimize or prevent the entry of particles into interior air space 30. Face seal 160 is thus a sheet-like material that extends inwardly from perimeter 33 of mask body 20 and that is sufficiently conformable to adjust to the contours of a wearer's face when respirator 10 is worn by a wearer. When respirator 10 is worn, portions of face seal 160 may, in conforming to the wearer's face, deflect slightly forwardly (that is, toward bulbous portion 35 of mask body 20) e.g. so as to maintain slight pressure against the wearer's face e.g. so as to maintain an air tight seal.

A face seal 160 may be attached to mask body 20, e.g. to perimeter 33 of mask body 20, by any desired attachment mechanism or method. Such methods might include e.g. ultrasonic bonding, thermal bonding, use of an adhesive such as a pressure-sensitive adhesive, hot-melt adhesive, radiation-curable adhesive, use of a mechanical fastener such as one or more staples, clips, and so on, and any combination of such methods. The attachment of face seal 160 to mask body 20 may be performed e.g. substantially continuously around the entirety of perimeter 33 of mask body 20; or it may only be performed at selected locations of perimeter 33.

In some embodiments, a face shield 160 may be positioned forwardly of nose pads 21 and 26. In other embodiments, a face shield 160 may be positioned rearwardly of nose pads 21 and 26 (e.g., the entirety of both tabs may be positioned forwardly of the face shield), as in the exemplary arrangement of FIG. 9. It will be appreciated that in the latter type of design, nose pads 21 and 26 may not necessarily come into direct contact with the wearer's nose. Rather, when respirator 10 is worn, they may press rearwardly against a local area of the face seal so as to cause that area of the face seal to bulge rearward as shown in exemplary embodiment in FIG. 9. Thus, the presence of the nose pads may enhance the ability of the face seal to seal in the area of the wearer's nose. In the exemplary design of FIG. 9, the nose pads are molded to have rearwardly convex portions (e.g., in the manner of FIG. 6) that can enhance this affect still further.

Face seal 160 may be made of any suitable material. In some embodiments, the same face seal material that is used to provide the face seal may also serve as a functional material for a functional layer of the nose pads. The face seal material may be conformable and in specific embodiments may be elastic (e.g., with an elongation at break of at least about 50, 100, or 200%). In some embodiments, the face seal may be impermeable to airflow. In particular embodiments, the face seal may comprise a woven or nonwoven web with an air-impermeable film laminated thereto. In specific embodiments, a face seal may comprise at least one water-vapor-breathable layer that is also liquid-water repellant, as described in U. S. Patent Application Publication 20140190492 to Noh, which is incorporated by reference in its entirety herein. (In this context the terms water-vapor breathable and liquid-water repellant are defined as set forth in the '492 Publication.)

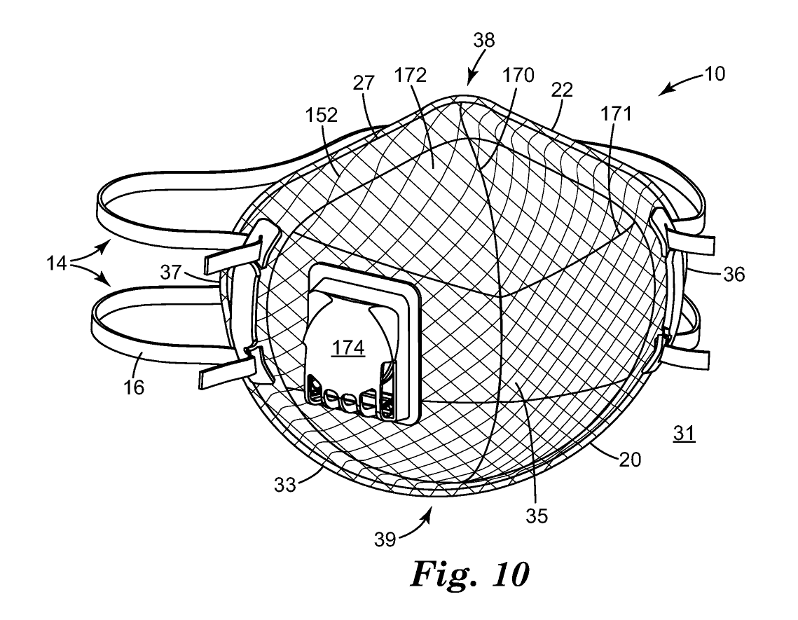

In some embodiments, a respirator 10 may comprise a mask body 20 that is laterally compressible as shown in exemplary embodiment in FIG. 10. By this is meant that the mask body is configured so that the application of laterally-inward pressure (e.g. by a user's fingers, when the respirator is not on the user's face) will cause first and second lateral portions 171 and 172 of the mask body to move toward each other e.g. in a clamshell manner. Such laterally-inward pressure can be applied by grasping the lateral edges 36 and 37 of the mask body and squeezing them toward each other. Such arrangements can be achieved e.g. by shaping the mask body to comprise a single, laterally-centered fold line 170 as shown in exemplary embodiment in FIG. 10. The term fold line broadly encompasses any arrangement in which laterally-central portion 170 of the mask body is more able to deflect (e.g., is somewhat less stiff) than other portions 171 and 172 that laterally flank it. (This effect can be augmented e.g. by molding the mask body so that portion 170 has a smaller radius of curvature than portions 171 and 172 that laterally flank it.) Such arrangements can provide that when pressure is applied by a user e.g. to lateral edges 36 and 37 of the mask body, the mask body can at least partially laterally compress (fold). This can allow the respirator to be e.g. temporarily folded so as to fit into a wearer's pocket.

The ability to laterally compress respirator 10 in this manner does not change the fact that the herein-disclosed respirator is a molded, cup-shaped respirator that is distinguished from so-called “flat-fold” respirator masks. A “flat-fold” respirator will have a mask body that comprises one or more folds, pleats, and/or doubled-up layers to facilitate the respirator being e.g. packaged and provided to a user in a flat-folded state. The mask body must be expanded (by active manipulation by the user) from this flat-folded state into an expanded shape in order to be worn. Upon being removed, a mask body of a flat-fold respirator will often at least partially collapse back down toward its original, flat-folded state without any action being required to promote this process. In contrast, the molded cup-shaped mask body disclosed herein does not require any active manipulation by a user (that is, it does not need to be expanded or unfolded) in order to be worn. Moreover, it merely has a (single) fold line that allows the mask body to be laterally compressed e.g. if desired for temporary storage in a pocket; the mask body will maintain and retain its cup shape unless actively laterally compressed. If the folding pressure is removed, the mask body will naturally expand back to the cup shape without any active manipulation being required by the user. Thus in summary, the ability of a cup-shaped, molded respirator as disclosed herein to be laterally compressed, does not cause such a respirator to be a “flat-fold” respirator as known in the art. Specific examples of “flat-fold” respirators that are distinguished from respirators comprising a cup-shaped, molded mask body as disclosed herein, are found in e.g. U.S. Pat. Nos. 8,074,660 and 9,012,013, both to Duffy.

In many embodiments, folding line 170 will be aligned with vertical bisector 19 of the mask body as shown in exemplary manner in FIGS. 9 and 10. (Harness 14 is omitted from the rear view of FIG. 9 for clarity but is shown in the front view of FIG. 10.) When the mask body is at least partially folded along this fold line, portions 171 and 172 of the mask body may be brought into proximity with each other. In particular embodiments, lateral edges 36 and 37 of the mask body may be brought into proximity with each other. Such arrangements may further distinguish the presently disclosed respirator from those that rely on one or more fold lines that are oriented laterally along the mask body rather than vertically along the mask body.

Respirator 10 may comprise any suitable exhalation valve(s), to facilitate purging exhaled air from interior air space 30. An exhalation valve may improve wearer comfort by allowing warm moist exhaled air to rapidly leave interior air space 30. Essentially any exhalation valve that can be properly secured to the mask body may be used, and may be attached to the mask body using any suitable technique. To enhance the ability to fold the mask body as described above, such an exhalation valve 174 may be laterally offset from the fold line of the mask body (as in the exemplary design of FIG. 10) e.g. so that no portion of the valve is intersected by the vertical bisector of the mask body. This can ensure that the valve does not physically interfere with the ability to fold the mask body along the fold line.

It will be appreciated however that the thickness (depth) of the exhalation valve may prevent the mask body from being folded “completely” flat. In fact, the thickness of the exhalation valve in combination with the thickness and/or slightly arcuate shape of lateral portions 171 and 172 of the mask body, may cause that when the respirator is folded to its maximum possible extent, the total (overall) thickness of the folded respirator may still be at least about 25, 30, 35, 40, 45, or 50 mm. These factors thus further distinguish the present respirator from so-called flat fold respirator masks.

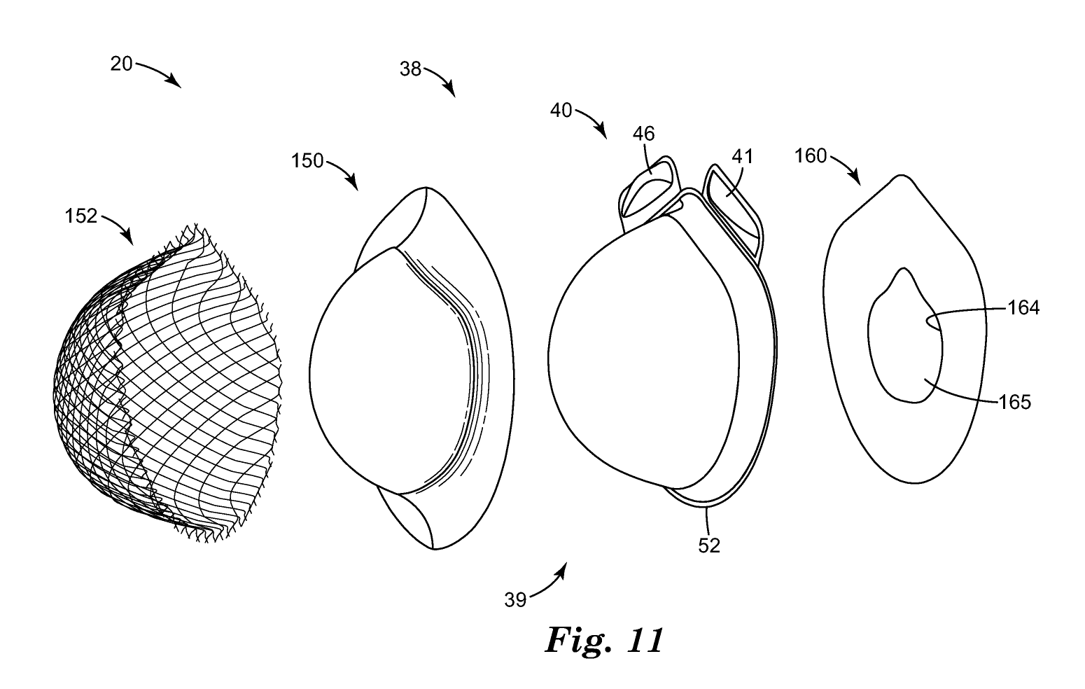

As noted, mask body 20 may be comprised of various layers, at least one of which is a molded layer (e.g., a shaping layer) and at least one of which is a filter layer (noting that in some embodiments the same layer may serve as both a shaping layer and a filter layer). Any one of these layers or the other layers mentioned herein, or any combination of these layers, may be the source from which tabs 41 and 46 integrally extend. One exemplary arrangement is depicted in FIG. 11, with the various layers exploded away from each other (and with ancillary components such as e.g. an exhalation valve and a harness being omitted for clarity). The outermost layer of mask body 20 of FIG. 11 is a reinforcing netting 152 that is molded into a cup shape. Such a layer, if present, can enhance the stiffness, mechanical durability, and/or abrasion resistance of the respirator. The next layer is a filter layer 150, described later in more detail. An outer cover layer may be present outwardly of filter layer 150 (e.g., a cover web may be laminated to the filter layer) particularly if a reinforcing netting is not present. The next layer is a shaping layer 40, and in the particular embodiment of FIG. 11 is the layer from which tabs 41 and 46 integrally extend (although such tabs will be inwardly folded in the finished product, in FIG. 11 they are shown unfolded for ease of description). A shaping layer is molded into a cup shape and thus can serve to establish and maintain the cup shape of the molded respirator. A shaping layer can be comprised of any suitable material as described later herein. The innermost layer is a face seal 160, as described previously herein.

Mask body 20 will comprise at least one filter layer 150, as shown in exemplary embodiment in FIG. 11. Such a filter layer can include one or more layers of filter media suitable for removing particles potentially present in an exterior air space. That is, multiple layers of similar or dissimilar filter media may be used to construct filter layer 150. A filter layer 150 may conveniently be generally low in pressure drop, for example, less than about 20 to 30 mm H₂O at a face velocity of 13.8 centimeters per second, to minimize the breathing work of the mask wearer. A filter layer 150 may be comprised of one or more webs of fine inorganic fibers (such as fiberglass) or polymeric synthetic fibers. Synthetic polymeric fiber webs may include electret charged polymeric microfibers that are produced from processes such as melt-blowing. Polyolefin microfibers formed from polypropylene and that are surface fluorinated and/or electret charged, to produce non-polarized trapped charges, may provide advantageous utility for particle-filtering applications. A layer of filter layer 150 or, a separate filter layer 150, may provide a sorbent function for removing unwanted or odorous gas or vapor molecules from the breathing air. Any suitable sorbent (which term broadly encompasses both absorbents and adsorbents) may be used, and may be provided e.g. as a powder or granules that are retained in a filter layer by adhesives, binders, or fibrous structures. Sorbent materials such as activated carbons, that are chemically treated or not, porous alumna-silica catalyst substrates, and alumna particles are examples of sorbents that may be useful in certain applications.

Essentially any suitable material may be used e.g. as a particle-filtering material of layer 150. Webs of melt-blown fibers, such as those taught in Wente, Van A., Superfine Thermoplastic Fibers, 48 Indus. Eng. Chem., 1342 et seq. (1956), especially when in a persistent electrically charged (electret) form are especially useful. Such melt-blown fibers may be e.g. microfibers (commonly referred to as BMF for “blown microfiber”) that have an effective fiber diameter less than about 20 micrometers (μm), typically about 1 to 12 μm. Particularly preferred may be BMF webs that contain fibers formed from polypropylene, poly(4-methyl-1-pentene), and combinations thereof. Electrically charged fibrillated-film fibers also may be suitable, as well as rosin-wool fibrous webs and webs of glass fibers or solution-blown, or electrostatically sprayed fibers, especially in microfiber form. Nanofiber-containing webs also may be used.

Electric charge can be imparted to at least some of the fibers of a filter layer 150 e.g. by contacting the fibers with water as disclosed in U.S. Pat. No. 7,765,698 to Sebastian, U.S. Pat. No. 6,824,718 to Eitzman, and U.S. Pat. No. 6,783,574 to Angadjivand. Electric charge also may be imparted to the fibers by corona charging as disclosed in U.S. Pat. No. 4,588,537 to Klasse or by tribocharging as disclosed in U.S. Pat. No. 4,798,850 to Brown. Any combination of such methods may be used. If desired, additives can be included in the fibers to enhance the ability of the fiber material to attain and maintain electric charge. If desired, fluorine atoms can be disposed at the fiber surfaces in the filter layer to improve filtration performance in an oily mist environment. Filter layers and suitable materials for use therein are described in detail in U.S. Patent Application Publication No. 2012/0125342 to Gebrewold, which is incorporated by reference in its entirety herein.

In some embodiments, a filter layer may be molded (e.g. thermoformed) to have a relatively stable cup shape. In other embodiments, a filter layer may merely be sufficiently conformable (e.g. limp) to conform to a cup shape as established by other layers (e.g. a shaping layer) of a mask body. (In such embodiments, a relatively conformable filter layer may be e.g. sandwiched between other layers so that the filter layer is formed and held in a cup shape.) In some embodiments such an arrangement may be facilitated by using a filter layer that, although not exhibiting a stable cup shape, is not perfectly flat before being incorporated into the mask body. Rather, a filter layer may take the form of e.g. a folded sheet that is imparted with an arcuate edge along the fold line, such that then the sheet is unfolded, the sheet exhibits e.g. a bicorn shape with an arcuate ridge that extends along the (former) fold line.

In some embodiments, mask body 20 will comprise at least one shaping layer. Often, it may be convenient that the shaping layer serve as layer 40 from which tabs 41 and 46 integrally extend, as in the exemplary arrangement of FIG. 11. A shaping layer can be provided by any material that is able to be molded into a cup shape and that retains the cup shape thereafter, and that allows sufficient airflow therethrough to allow the functioning of respirator 10. Such layers often take the form of porous fibrous webs, e.g. nonwoven webs that include bonding fibers (e.g., multicomponent fibers (often referred to as “melty” fibers”) that have at least a portion that is capable of bonding to adjacent fibers upon being heated and cooled). A shaping layer may include any of the nonwoven layers or materials listed later herein. In some embodiments, the shaping layer may be an airlaid web or a carded web, comprising e.g. bicomponent bonding fibers and/or polyester fibers. Shaping layers and fibers suitable for inclusion therein are described in detail e.g. in U.S. Pat. No. 6,923,182 to Angadjivand, and in U.S. Pat. No. 4,807,619 to Dyrud and U.S. Pat. No. 4,536,440 to Berg, all of which are incorporated by reference herein in their entirety.

In some embodiments, mask body 20 may further comprise additional layers, e.g. one or more of outer or inner cover layers, pre-filter layers, decorative layers, and so on. In some embodiments, an additional layer that is positioned forward of filter layer 150 (e.g. an outer cover layer) may act as a prefilter to remove large objects (e.g., hair, large dust particles, etc.) that may be present in the exterior air space, and/or may serve to protect filter layer 150 from abrasion and/or from exposure to excessive contaminants, dirt, and grime, that may be present in the exterior air space. Such an outer cover layer may instead serve e.g. as a decorative layer; or, it may serve both a pre-filtering and a protective function.

In some embodiments, an additional layer (e.g., an inner cover layer) may be provided rearward of filter layer 150. Such a layer may protect the rearward side of the filtering layer, may provide enhanced comfort when in contact with the wearer's skin, and so on. An inner cover layer may not necessarily provide any substantial filtering benefits, although it may if desired. To obtain a suitable degree of comfort, an inner cover layer may be a web with a comparatively low basis weight and may be formed from comparatively fine fibers. Fibers used in an inner cover web often have an average fiber diameter of about 5 to 24 micrometers, typically of about 7 to 18 micrometers, and more typically of about 8 to 12 micrometers. The inner cover web material may have a degree of elasticity (typically, but not necessarily, 100 to 200% at break) and may be plastically deformable. Suitable materials for an inner cover web include blown microfiber (BMF) materials, particularly polyolefin BMF materials, for example polypropylene BMF materials (including polypropylene blends and also blends of polypropylene and polyethylene). Spun-bond fibers also may be used. Other potentially suitable materials are polyester fibers (e.g. PET) and polyester fibers intermixed with e.g. polyurethane fibers. If desired, a thin conformal film (e.g. of a thermoplastic elastomer such as polyurethane) may be provided e.g. on a rearward surface of an inner cover web.

In general, any of the herein-described layers of mask body 20 may include a nonwoven web such as e.g. a melt-blown web (e.g., a so-called blown-microfiber (BMF) web), a spun-bond web, a spun-laced (e.g., hydroentangled) web, a carded web, an air-laid web, a wet-laid web, and so on. Mixtures of multiple fiber types (e.g., melt-blown fibers along with staple fibers) may be used, as may multiple layers of different fiber types (e.g. so-called SMS laminates that comprise an inner layer of melt-blown fibers sandwiched between two layers of spunbond fibers), and so on. The fibers of such non-woven webs may be bonded or otherwise arranged so as to form a coherent web by any suitable method, e.g. hydroentangling, needle-punching, thermal bonding, the use of a binder (e.g. a latex or particular binder, or by the use of bonding fibers as described earlier herein), and so on. All such layers should allow sufficient passage of air so that when all of the layers are combined in a stack, respirator 10 functions adequately without involving an unacceptably high pressure drop.

As previously noted, in some embodiments first and second tabs 41 and 46 may each be an integral extension of a layer 40 that is an assembly comprising multiple layers (which will be referred to for convenience as sublayers). Thus, tabs 41 and 46 may integrally extend from a filter layer, a shaping layer, an outer cover layer, an inner cover layer, or from any multilayer combination thereof. In various specific embodiments, tabs 41 and 46 may each be an integral extension of a filter sublayer and a shaping sublayer; a filter sublayer and an outer cover sublayer; a shaping sublayer and an inner cover sublayer; a filter sublayer, an outer cover sublayer, and a shaping sublayer; a filter sublayer, a shaping sublayer, and an inner cover sublayer; or, a filter sublayer, a shaping sublayer, an outer cover sublayer, and an inner cover sublayer.

In some embodiments, a nose clip (made e.g. of any suitable malleable metal or deformable or deflectable plastic) can be secured on the inner or outer face of mask body 20 or between layers of mask body 20, centrally adjacent to its upper edge, to enhance the ability of the mask to be deformed or shaped in this region. However, in some embodiments no nose clip of any kind is present in or on mask body 20. (In fact, in many embodiments the use of nose pads as disclosed herein may minimize or eliminate the need for a nose clip.) In some embodiments, one or more foam nose pads (e.g., strips of foam) may be secured on the inward face of mask body 20, to enhance the comfort with which the mask rests on the nose. However, in some embodiments no foam nose pad of any kind may be present in or on any part of mask body 20. In some embodiments, a support structure comprising one or more solid plastic pieces, e.g. molded plastic pieces, may be provided e.g. to assist in maintaining the mask body in a generally cup-shaped configuration. Such a support structure might comprise e.g. one or more injection molded members e.g. as described in U. S. Patent Application Publication 2012/0125342 to Gebrewold. In other embodiments, no such support structure of any kind is present in or on mask body 20.

Any suitable strap or straps, e.g. made of an elastic material, may be used to provide harness 14. Such straps (e.g., straps 16 as depicted herein) may be secured to mask body 20 by any suitable means including adhesive means, bonding means, or mechanical means. A strap 16 could be, for example, ultrasonically welded to the mask body 20 or mechanically attached by other means such as staples. Adjustable buckles may be provided on the harness 14 to allow the straps 16 to be adjusted in length. In some embodiments, a single strap (with a first end that is connected to a first lateral edge of the mask body, and a second end that is connected to a second lateral edge of the mask body) may be used. In other embodiments, two or more such straps (e.g., an upper strap and a lower strap) that each extend from one lateral edge to another lateral edge of the mask body may be used, in the general manner of FIG. 10. In other multiple-strap embodiments, a first strap may have first and second ends that are both connected to a first lateral edge of the mask body, and a second strap may have first and second ends that are both connected to a second lateral edge of the mask body, as with straps 16 depicted in FIGS. 1 and 2. In such embodiments, it may be convenient to provide a connecting device (e.g., a hook 17 as shown in FIGS. 1 and 2) that can be used to connect portions of the two straps to each other behind the wearer's head, so as to enhance the holding of the respirator securely against the wearer's face.

Regardless of the particular design of harness 14, it permits respirator 10 to be worn by a wearer and then removed; or, to be worn, removed, worn again, removed again, etc., commensurate with the ordinary use of such a respirator. In at least some embodiments respirator 10 may be disposable, meaning that in ordinary use it is disposed after an appropriate period of use, whether such period of use occurs in one continuous episode, or is intermittent in nature.

Respirator 10 can be manufactured using any suitable process. In some embodiments, all of the layers to be included and shaped (e.g. one or more of a filter layer, a shaping layer, an inner cover layer, an outer cover layer, and/or a reinforcing netting) can be obtained as flat sheets, stacked together, and then molded (e.g. thermoformed) by application of heat and pressure, in a single operation. Depending on the composition of the various layers, some bonding between the layers may occur during the molding operation. In addition to this bonding (or, if at least one layer or layers are molded separately and are then brought together to be bonded) the layers may be bonded to each other e.g. at least at some locations around the perimeter of the resulting mask body. Suitable bonding methods may include e.g. ultrasonic bonding, thermal bonding, use of an adhesive such as a pressure-sensitive adhesive, hot-melt adhesive, radiation-curable adhesive, use of a mechanical fastener such as one or more staples, clips, and so on, and any combination of such methods. The bonding may be performed e.g. substantially continuously around the entirety of perimeter 33 of mask body 20; or it may only be performed at selected locations of perimeter 33. Bonding may also be performed in selected locations of bulbous portion 35 of mask body 20, as long as such bonding does not unacceptably interfere with the ability of air to pass through mask body 20. Particularly if the tabs are multilayer structures, the tabs can be e.g. ultrasonically welded e.g. along some or all of their edges and/or in selected locations throughout the area of each tab, to enhance the degree to which the sublayers of the tab are bonded to each other.

In some embodiments all of the layers of the mask body (not including a face seal) may be molded layers (whether molded collectively or molded separately and then assembled together). In other embodiments at least one layer (e.g., a filter layer) may not necessarily be a molded layer but may be sufficiently pliable to conform to the molded layers and to be held in that configuration after the layers are bonded together.

If one or more functional layers are to be present on the nose pads, the desired functional layer may be applied to at least a portion of a sheet of material that will form layer 40, either before or after the sheet is molded to form the cup shape. For example, the functional layer might be applied as a stripe along a portion of the sheet that will form the tabs, which stripe may optionally extend onto part of the sheet that will be molded to form the bulbous portion of layer 40 (e.g. to provide an arrangement of the general type shown in FIG. 8). If desired, a 3-D shape may be formed into the functional material as noted above.

If a face seal 160 is to be present, it can be attached at any suitable step in the process. For example, in some embodiments mask body 20 may be formed into a desired shape and face seal 160 may then be attached thereto, in any suitable manner. Such attachment could be performed with the tabs still in their initial (unfolded) configuration, in which case the tabs would be located rearward of the face seal upon being folded. Or, such attachment could be performed with the tabs already folded inwardly, in which case the tabs would be located forward of the face seal upon the face seal being attached.

In particular embodiments, a sheet of face seal material may be obtained and an opening 165 may be cut (e.g. by die or laser cutting) of a shape and size appropriate to provide terminal inward edges 164 of the face seal of the finished respirator. The sheet of face seal material can then be brought against the forward side of a cup-shaped mask body (or precursor), so that the bulbous portion of the cup-shaped mask body protrudes forwardly through the opening of the face seal sheet. The face seal material can then be bonded (in any desired manner) to the perimeter of e.g. an outer layer of the mask body. It may be convenient that the bonding of the face seal material may be performed in the same process in which the other layers of the mask body are bonded together around the perimeter of the mask. For example, ultrasonic bonding may be used to bond all of the layers together in the same operation. In some embodiments the bonding process can be performed with the tabs still in their initial, unfolded position so that if desired, the nose pads will comprise face seal material bonded to a major surface thereof. The excess face seal material that laterally surrounds the perimeter of the mask body can be then trimmed (e.g. along with any excess material of the other layers) leaving the face seal material bonded to the perimeter of the mask body and circumferentially surrounding the portion of the mask body that protrudes forwardly through the opening of the face seal sheet.

The nose pads can then be inwardly folded as described above. After this, the face shield material can be inverted rearwardly over and around perimeter 33 of the mask body (which process will be facilitated by the face seal material being at least somewhat elastic). This will cause face seal 160 to reach the rearwardmost position (and, specifically, to be positioned rearwardly of nose pads 21 and 26) as shown in exemplary embodiment in FIGS. 9 and 11. It will be appreciated that such an operation will cause the face seal material to be outwardly wrapped around the perimeter edges of the various layers of the mask body, as opposed to the generic representation shown in FIG. 11.

Other components (e.g., harness 14, exhalation valve 174, etc.) can be attached to mask body 20 using any convenient method, at any convenient time. Although in the exemplary embodiments of FIGS. 1 and 2, straps 16 are shown as connected to tabs 34 that extend outwardly beyond perimeter 33 of mask body 20, in general such straps can be attached to any portion or component of mask body 20 (including direct attachment to perimeter 33 or other portion of mask body 20). Moreover, such outwardly-extending tabs (and, in general, any such outwardly-extending projections) may be neglected for the purpose of defining perimeter 33 of mask body 20. In some embodiments, mask body 20 may include strap anchors (made e.g. of injection molded plastic, but not to be confused with the aforementioned molded support structures of certain respirators of the art) that are attached to mask body 20 and to which straps 16 may be attached, as in the exemplary embodiment of FIG. 10. Finished respirators 10 can then be packaged as desired. In some embodiments two or more finished respirators can be packaged together in a container to form a kit, with the mask body of each respirator in a cup-shaped configuration and not in a flat-folded configuration. Such a kit may include e.g. instructions for use.

### List of Exemplary Embodiments

Embodiment 1 is a filtering face-piece respirator that comprises: a cup-shaped, molded mask body that comprises a rearward open end with a perimeter; a first integral nose pad that is provided by a first inwardly-folded tab that is an integral extension of at least one layer of the mask body and that extends inwardly from a first upper section of the perimeter of the mask body; a second integral nose pad that is provided by a second inwardly-folded tab that is an integral extension of the at least one layer of the mask body and that extends inwardly from a second upper section of the perimeter of the mask body; wherein the first and second integral nose pads are respectively positioned on first and second sides of a vertical bisector of the mask body with a gap therebetween, and wherein the vertical bisector intersects the gap between the first and second integral nose pads.

Embodiment 2 is the respirator of embodiment 1 wherein the layer of the mask body from which the first and second tabs integrally extend is chosen from a filtration layer, an outer cover layer, and an inner cover layer. Embodiment 3 is the respirator of embodiment 1 wherein the layer of the mask body from which the first and second tabs integrally extend is a shaping layer, and wherein the mask body further comprises at least one filtration layer. Embodiment 4 is the respirator of any of embodiments 1-3 wherein the layer of the mask body and the first and second tabs integrally extending therefrom, comprise multiple sublayers.

Embodiment 5 is the respirator of any of embodiments 1-4 wherein the first and second tabs are each molded to comprise a rearwardly convex portion of the first and second integral nose pads. Embodiment 6 is the respirator of any of embodiments 1-5 wherein the first and second tabs each comprise at least one functional layer that is disposed on, and attached to, a major surface of the tab. Embodiment 7 is the respirator of embodiment 6 wherein the functional layer is chosen from a non-slip layer, an occluding layer, a decorative layer, a cushioning layer, and a wicking layer. Embodiment 8 is the respirator of any of embodiments 6-7 wherein the functional layer is disposed only on the first and second tabs with no portion of the cup-shaped, molded mask body having the functional layer disposed thereon. Embodiment 9 is the respirator of any of embodiments 6-7 wherein the functional layer is disposed on the first and second tabs and is also disposed in a stripe along an upper portion of the mask body, and wherein the functional layer of the mask body, the functional layer of the first tab, and the functional layer of the second tab, are all integral portions of the functional layer. Embodiment 10 is the respirator of any of embodiments 6-9 wherein the first and second tabs and the functional layers thereof, are each molded to comprise a rearwardly convex portion of the first and second integral nose pads.

Embodiment 11 is the respirator of any of embodiments 1-10 wherein the respirator comprises a face seal that is comprised of a face seal material and that is connected to the perimeter of the mask body and extends inwardly from the perimeter of the mask body to terminate at an inner edge of the face seal. Embodiment 12 is the respirator of embodiment 11 wherein the first and second tabs each comprise at least one functional layer that is disposed on a major surface of the tab and wherein the functional layer of the first and second tabs is comprised of the face seal material. Embodiment 13 is the respirator of any of embodiments 11-12 wherein the entirety of each of the first and second tabs is positioned forwardly of the face seal. Embodiment 14 is the respirator of embodiment 13 wherein the first and second tabs respectively press rearward against first and second sections of the face seal so as to each cause the formation of first and second rearward bulges in the face seal.

Embodiment 15 is the respirator of any of embodiments 1-14 wherein the mask body comprises a folding line that is aligned with the vertical bisector of the mask body and that, when the respirator is not being worn, allows the mask body to be laterally compressed so that first and second lateral edges of the mask body are brought into proximity to each other. Embodiment 16 is the respirator of embodiment 15 wherein the mask body comprises an exhalation valve that is a laterally-offset valve no portion of which is intersected by the vertical bisector of the mask body.

Embodiment 17 is the respirator of any of embodiments 1-16 wherein the mask body comprises, in order from the front of the mask body, a reinforcing netting layer, a filter layer, a shaping layer, and a face seal; and, wherein the first and second tabs each integrally extend from the shaping layer. Embodiment 18 is the respirator of embodiment 17 wherein the face seal comprises at least one water-vapor-breathable layer that is also liquid-water-repellent. Embodiment 19 is the respirator of any of embodiments 1-16 wherein the mask body comprises, in order from the front of the mask body, a filter layer, a reinforcing netting layer, a shaping layer and a face seal.

Embodiment 20 is the respirator of any of embodiments 1-19, wherein the respirator comprises a harness that comprises at least one elastic strap and that allows the respirator to be mounted and retained on the head of a wearer. Embodiment 21 is the respirator of any of embodiments 1-20 with the proviso that the mask body does not comprise any deformable nose clips and does not comprise any foam nose pads.

Embodiment 22 is a kit comprising at least two of the respirators of any of embodiments 1-21, wherein the respirators are packaged together in a container, with the mask body of each respirator in a cup-shaped configuration and not in a flat-folded configuration.

Embodiment 23 is a method of making a filtering face-piece respirator comprising a cup-shaped, molded mask body, the method comprising: molding a portion of at least one porous, fibrous sheet to comprise at least one layer of a mask body, the molded portion of the sheet having a bulbous, cup-shape portion bounded by a perimeter; cutting the sheet to have first and second tabs that integrally extend outwardly from first and second sections of the perimeter of the molded portion of the sheet; and, folding the first and second tabs inwardly to respectively provide at least one layer of first and second integral nose-pads of the respirator, wherein the first and second integral nose pads are respectively positioned on first and second sides of a vertical bisector of the mask body with a gap therebetween.

Embodiment 24 is the method of embodiment 23, as used to make a respirator of any of embodiments 1-21.

It will be apparent to those skilled in the art that the specific exemplary structures, features, details, configurations, etc., that are disclosed herein can be modified and/or combined in numerous embodiments. All such variations and combinations are contemplated by the inventor as being within the bounds of the conceived invention not merely those representative designs that were chosen to serve as exemplary illustrations. Thus, the scope of the present invention should not be limited to the specific illustrative structures described herein, but rather extends at least to the structures described by the language of the claims, and the equivalents of those structures. To the extent that there is a conflict or discrepancy between this specification as written and the disclosure in any document incorporated by reference herein, this specification as written will control.

What is claimed is:

1. A filtering face-piece respirator that comprises:
a cup-shaped, molded mask body that comprises a rearward open end with a perimeter;
a first integral nose pad that is provided by a first inwardly-folded tab that is an integral extension of at least one layer of the mask body and that extends inwardly from a first upper section of the perimeter of the mask body;
a second integral nose pad that is provided by a second inwardly-folded tab that is an integral extension of the at least one layer of the mask body and that extends inwardly from a second upper section of the perimeter of the mask body;
wherein the first and second integral nose pads are respectively positioned on first and second sides of a vertical bisector of the mask body with a gap therebetween, and wherein the vertical bisector intersects the gap between the first and second integral nose pads.

2. The respirator of claim 1 wherein the layer of the mask body from which the first and second tabs integrally extend is chosen from a filtration layer, an outer cover layer, and an inner cover layer.

3. The respirator of claim 1 wherein the layer of the mask body from which the first and second tabs integrally extend is a shaping layer, and wherein the mask body further comprises at least one filtration layer.

4. The respirator of claim 1 wherein the layer of the mask body and the first and second tabs integrally extending therefrom, comprise multiple sublayers.

5. The respirator of claim 1 wherein the first and second tabs are each molded to comprise a rearwardly convex portion of the first and second integral nose pads.

6. The respirator of claim 1 wherein the first and second tabs each comprise at least one functional layer that is disposed on, and attached to, a major surface of the tab.

7. The respirator of claim 6 wherein the functional layer is chosen from a non-slip layer, an occluding layer, a decorative layer, a cushioning layer, and a wicking layer.

8. The respirator of claim 6 wherein the functional layer is disposed only on the first and second tabs with no portion of the cup-shaped, molded mask body having the functional layer disposed thereon.

9. The respirator of claim 6 wherein the functional layer is disposed on the first and second tabs and is also disposed in a stripe along an upper portion of the mask body, and wherein the functional layer of the mask body, the functional layer of the first tab, and the functional layer of the second tab, are all integral portions of the functional layer.

10. The respirator of claim 6 wherein the first and second tabs and the functional layers thereof, are each molded to comprise a rearwardly convex portion of the first and second integral nose pads.

11. The respirator of claim 1 wherein the respirator comprises a face seal that is comprised of a face seal material and that is connected to the perimeter of the mask body and extends inwardly from the perimeter of the mask body to terminate at an inner edge of the face seal.

12. The respirator of claim 11 wherein the first and second tabs each comprise at least one functional layer that is disposed on a major surface of the tab and wherein the functional layer of the first and second tabs is comprised of the face seal material.

13. The respirator of claim 11 wherein the entirety of each of the first and second tabs is positioned forwardly of the face seal.

14. The respirator of claim 13 wherein the first and second tabs respectively press rearward against first and second sections of the face seal so as to each cause the formation of first and second rearward bulges in the face seal.

15. The respirator of claim 1 wherein the mask body comprises a folding line that is aligned with the vertical bisector of the mask body and that, when the respirator is not being worn, allows the mask body to be laterally compressed so that first and second lateral edges of the mask body are brought into proximity to each other.

16. The respirator of claim 15 wherein the mask body comprises an exhalation valve that is a laterally-offset valve no portion of which is intersected by the vertical bisector of the mask body.

17. The respirator of claim 1 wherein the mask body comprises, in order from the front of the mask body, a reinforcing netting layer, a filter layer, a shaping layer, and a face seal; and, wherein the first and second tabs each integrally extend from the shaping layer.

18. The respirator of claim 17 wherein the face seal comprises at least one water-vapor-breathable layer that is also liquid-water-repellent.

19. The respirator of claim 1 wherein the mask body comprises, in order from the front of the mask body, a filter layer, a reinforcing netting layer, a shaping layer and a face seal.

20. The respirator of claim 1, wherein the respirator comprises a harness that comprises at least one elastic strap and that allows the respirator to be mounted and retained on the head of a wearer.

21. The respirator of claim 1 with the proviso that the mask body does not comprise any deformable nose clips and does not comprise any foam nose pads.

22. A kit comprising at least two of the respirators of claim 1, wherein the respirators are packaged together in a container, with the mask body of each respirator in a cup-shaped configuration and not in a flat-folded configuration.

23. A method of making a filtering face-piece respirator comprising a cup-shaped, molded mask body, the method comprising:
molding a portion of at least one porous, fibrous sheet to comprise at least one layer of a mask body, the molded portion of the sheet having a bulbous, cup-shape portion bounded by a perimeter;
cutting the sheet to have first and second tabs that integrally extend outwardly from first and second sections of the perimeter of the molded portion of the sheet; and,
folding the first and second tabs inwardly to respectively provide at least one layer of first and second integral nose-pads of the respirator, wherein the first and second integral nose pads are respectively positioned on first and second sides of a vertical bisector of the mask body with a gap therebetween.
